(19) United States
(12) Patent Application Publication
(10) Pub. No.: US 2015/0143300 A1
(43) Pub. Date: May 21, 2015

(54) CONJUNCTIVE MENU ORGANIZATION

(71) Applicant: Case Western Reserve University, Cleveland, OH (US)

(72) Inventors: Guo-Qiang Zhang, Orange Village, OH (US); Licong Cui, Cleveland, OH (US)

(21) Appl. No.: 14/541,292

(22) Filed: Nov. 14, 2014

Related U.S. Application Data
(60) Provisional application No. 61/904,665, filed on Nov. 15, 2013.

(51) Int. Cl. G06F 3/0482

(52) U.S. Cl. CPC G06F 3/0482
USPC 715/845

(57) ABSTRACT

Systems and methods are provided for displaying content items to a user. The user is allowed to select a plural, proper subset of a first set of categories, and a proper subset of a first set of subordinate items is displayed according to the selected plural, proper subset of the first set of categories by the user. The user then allowed to select a plurality of subordinate items of a displayed proper subset of the first set of subordinate items at the display, a proper subset of a second set of subordinate items is displayed according to the selected plurality of the proper subset of the first set of subordinate items.

### RELATED APPLICATIONS

This application claims priority from U.S. Provisional Patent Application Ser. No. 61/904,665, filed Nov. 15, 2013, the content of which is hereby incorporated by reference.

### FIELD OF THE INVENTION

The invention relates generally to information retrieval systems, and more specifically, the invention relates to a menu displaying information via a conjunctive organization scheme.

### BACKGROUND OF THE INVENTION

Consumer health portals represent a rich source of knowledge that can empower people with timely and current information for managing their health and promoting wellbeing, while maintaining a certain level of privacy. However, direct search is insufficient in addressing information access needs beyond simple lookups. The proliferation of online health information from government agencies, non-profit organizations, for-profit companies, and chatting and social networking sites presents myriad of challenges for information access. Even though the accuracy of information found on selected common topics is good among the top fourteen selected sites, coverage is poor and inconsistent. In some cases, more than ten steps of web-links did not lead to relevant information within the search results obtained.

### SUMMARY OF THE INVENTION

In accordance with an aspect of the present invention, a non-transitory computer readable medium stores executable instructions executable by an associated processor to perform a method for selectively displaying discrete content items to a user. The method includes displaying a first set of categories to the user, and allowing the user to select a proper subset of the first set of categories. A proper subset of a first set of subordinate items is then displayed to the user. Each of the first set of subordinate items is associated with at least one of the first set of categories. The proper subset of the first set of subordinate items includes only items from the first set of subordinate items that are associated with all of the selected proper subset of the first set of categories. The user is then allowed to select at least one of the displayed proper subset of the first set of subordinate items and a proper subset of a second set of subordinate items is displayed, each associated with at least one of the first set of subordinate items. The proper subset of the second set of subordinate items includes only items from the second set of subordinate items that are associated with all of the selected at least one of the first set of subordinate items.

In accordance with another aspect of the present invention, a method is provided for displaying content items to a user. The user is allowed to select a plural, proper subset of a first set of categories, and a proper subset of a first set of subordinate items is displayed according to the selected plural, proper subset of the first set of categories by the user. The user then allowed to select a plurality of subordinate items of a displayed proper subset of the first set of subordinate items at the display, and a proper subset of a second set of subordinate items is displayed according to the selected plurality of the proper subset of the first set of subordinate items.

In accordance with another aspect of the present invention, a system includes a processor, a display, an input device, and a set of at least one non-transitory computer readable medium operatively connected to the processor. The non-transitory computer readable medium stores executable instructions including a user interface configured to display a set of medical categories to the user at the display and allow the user to select a proper subset of the first set of medical categories via the input device and a conjunctive selection engine configured to determine a proper subset of a set of medical topics comprising only topics from the set of medical topics that are associated with all of the selected proper subset of the set of medical categories and provide the determined proper subset of the set of medical topics to the user interface for display. The user interface is further configured to allow the user to select at least one of the displayed proper subset of the first set of medical topics via the input device, with the conjunctive selection engine determining a proper subset of a set of content items comprising only content items from the set of content items that are associated with all of the selected proper subset of the set of medical topics.

### BRIEF DESCRIPTION OF THE DRAWINGS

The features, objects, and advantages of the invention will become more apparent from the detailed description set forth below when taken in conjunction with the drawings, wherein:

FIG. 1 illustrates one example of a system for conjunctive organization and retrieval of content in accordance with an aspect of the present invention;

FIG. 2 illustrates an example of a method for providing content items to a user in accordance with an aspect of the present invention;

FIG. 3 illustrates one example of a method for selectively displaying discrete content items to a user in accordance with an aspect of the present invention;

FIGS. 4-7 represent exemplary screenshots for an implementation of the method of FIG. 3 where the content items are medical articles; and

FIG. 8 is a schematic block diagram illustrating an exemplary system of hardware components capable of implementing examples of the systems and methods disclosed in FIGS. 1-3.

### DETAILED DESCRIPTION OF THE INVENTION

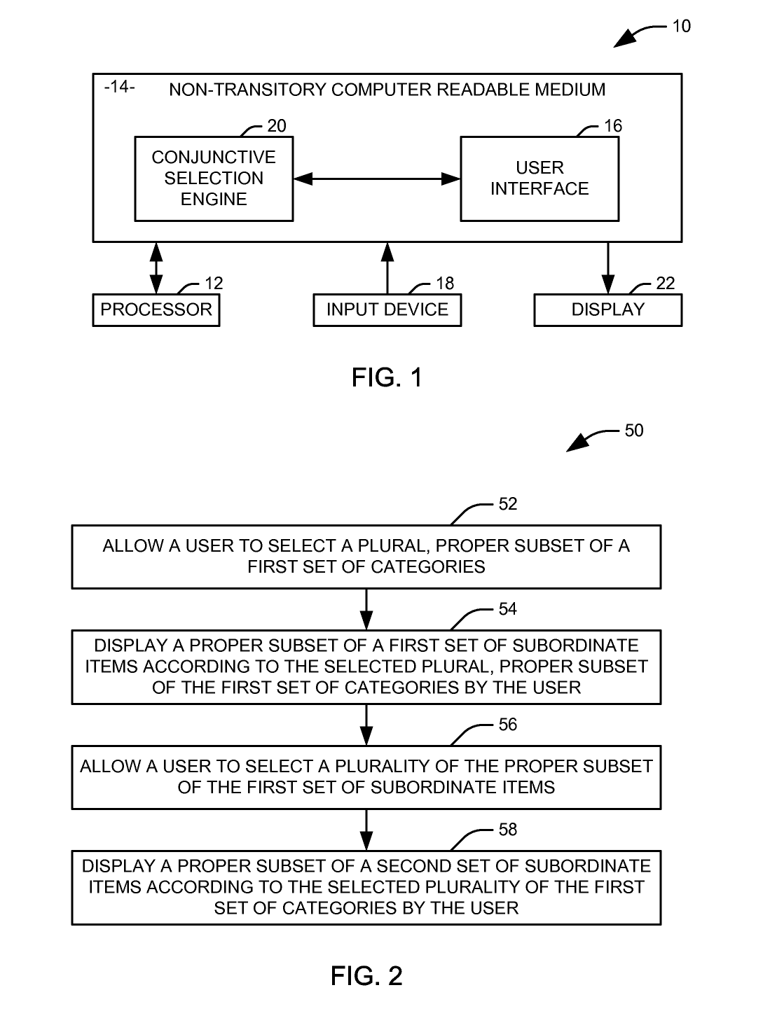

FIG. 1 illustrates one example of a system 10 for conjunctive organization and retrieval of content items in accordance with an aspect of the present invention. For example, each of the set of content items includes at least one of a document, a video, a webpage, a picture, and a hypertext link. The system 10 includes processor 12 and a set of at least one non-transitory computer readable medium 14, operatively connected to the processor, storing machine-readable instructions executable by the processor. The instructions include a user interface 16 configured to display a first set of medical categories to the user at the display and allow the user to select a proper subset of the first set of medical categories via an appropriate input device 18. It will be appreciated that the input device can include any appropriate means for communicating a selection to the system 10, including, for example, a mouse, keyboard, touchscreen, or a microphone.

A conjunctive selection engine 20 is configured to determine a proper subset of a first set of subordinate items in response to the user's selection. It will be appreciated that the “subordinate items” are items that belong to categories in a previous level of the conjunctive organization system, and can include additional categories or content items. It will be noted that a given subordinate item can be, and often will be, associated with more than one of the categories in the previous level of the system. In accordance with an aspect of the present invention, the proper subset of the first set of subordinate items includes only subordinate items that are associated with all of the selected categories. In other words, the conjunctive selection engine 20 provides the intersection of the sets of subordinate items belonging to the categories selected by the user. The subordinate items provided by the conjunctive selection engine 20 are then provided to the user interface 16 for display at an associated display 22.

It will be appreciated that the conjunctive search can take place across multiple levels. For example, a second set of subordinate items can each be associated with one of the first set of subordinate items. The user can select from the displayed first set of subordinate items, and the conjunctive selection engine 20 determines a proper subset of the second set of subordinate items that includes only those items that are associated with all of the selected items from the first set of subordinate items.

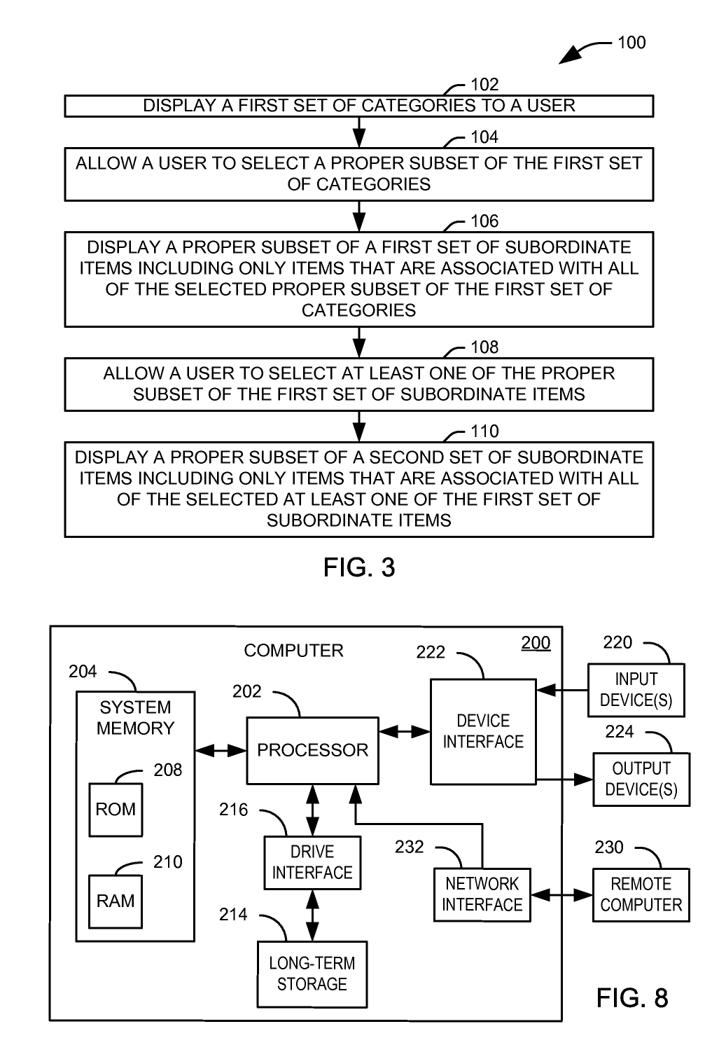

In view of the foregoing structural and functional features described above, example methods will be better appreciated with reference to FIGS. 2 and 3. While, for purposes of simplicity of explanation, the method of FIGS. 2 and 3 are shown and described as executing serially, it is to be understood and appreciated that the present invention is not limited by the illustrated order, as some actions could, in other examples, occur in different orders from that shown and described herein or could occur concurrently. It will be appreciated that some or all of each of these methods can be implemented as machine-readable instructions on a non-transitory computer readable medium.

FIG. 2 illustrates an example of a method 50 for providing content items to a user in accordance with an aspect of the present invention. For example, the content items can include one or more of documents, videos, webpages, pictures, and hypertext links. At 52, the user is allowed to select a plural, proper subset of a first set of categories. At 54, a proper subset of a first set of subordinate items is displayed according to the selection of the plural, proper subset of the first set of categories by the user. In one implementation, the proper subset of a first set of subordinate items is selected as each item from the first set of subordinate items that is associated with all of the selected first set of categories. Put differently, the various categories in the first set of categories can each have an associated subset of the first set of subordinate items, and the displayed subordinate items represent the intersection of the subsets associated with the selected categories. It will be appreciated that the assignment of the first set of subordinate items can be done by a human expert or an automated system. In one implementation, each of the first set of subordinate items is assigned to one of first set of categories by applying formal concept analysis, with each of the first set of categories representing an attribute of the formal concept analysis and each of the subordinate items representing an object of the formal concept analysis.

At 56, the user is allowed to select a plurality of subordinate items of a displayed proper subset of the first set of subordinate items. At 58, a proper subset of a second set of subordinate items is displayed according to the selected plurality of the proper subset of the first set of subordinate items. For example, the various categories in the first set of subordinate items can each have an associated subset of the second set of subordinate items, and the displayed subordinate items represent the intersection of the subsets associated with the selected members of the first set of subordinate items. In one implementation, the second set of subordinate items can represent the content items, allowing the user to select one or more desired items to review. Alternatively, the method 50 can continue through one or more additional levels of subordinate categories, at each step taking the intersection of the sets of subordinate items associated with the selected sets in the preceding level of subordinate items.

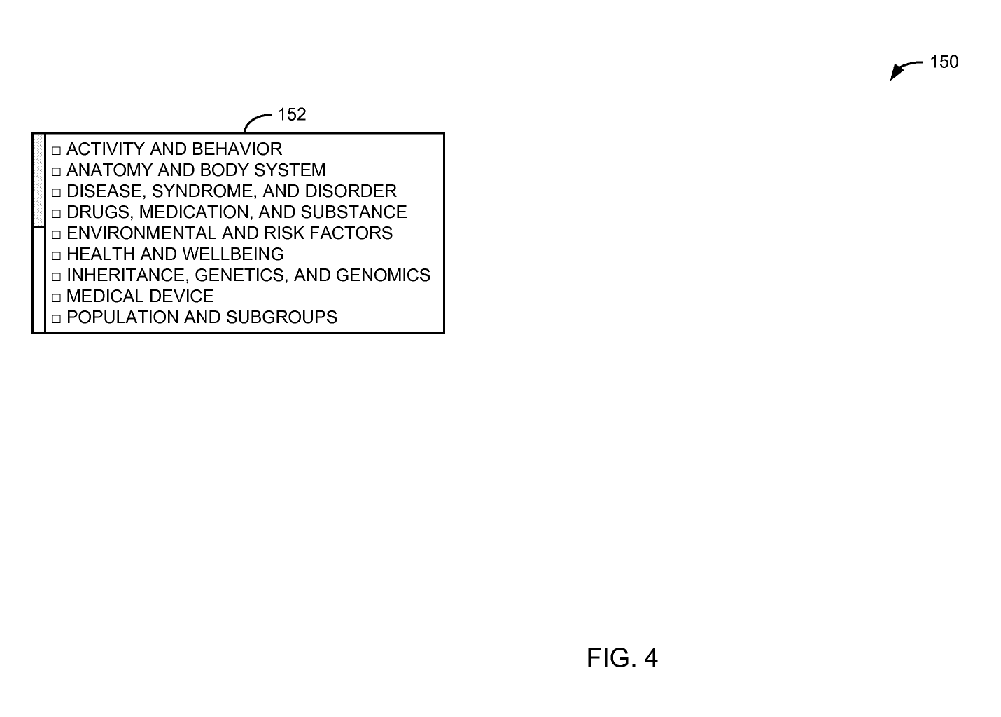

FIG. 3 illustrates one example of a method 100 for selectively displaying discrete content items to a user in accordance with an aspect of the present invention. At 102, a first set of categories is displayed to the user, representing a top level of categories in a conjunctive menu. In one implementation of a menu system for returning medical articles, each of the first set of categories is selected to comprise a set of at least one semantic type from the Unified Medical Language System. FIG. 4 represents a possible screenshot 150 for one example of this implementation. It will be noted that the set of top-level categories each represent a broad category covering a range of medical topics. A user seeking a specific content item can select each of the broad categories that relate to the specific content item.

At 104, the user is allowed to select a proper subset of the first set of categories, representing those categories the user expects to represent content items of interest. At 106, a proper subset of a first set of subordinate items is displayed. Each of the first set of subordinate items is associated with at least one of the first set of categories. In one implementation, the first set of subordinate items includes topic label tags (TLTs), such as content unique identifiers from the Unified Medical Language System. In accordance with an aspect of the present invention, the displayed proper subset of the first set of subordinate items can include only items from the first set of subordinate items that are associated with all of the selected proper subset of the first set of categories. In other words, each of the first set of categories is associated with a set of subordinate items, and the displayed proper subset of the first set of subordinate items represents the intersection of the sets associated with the categories selected by the user. In one implementation, the subordinate items are assigned to their associated categories by a human expert, although it will be appreciated that automated methods can be employed to associate subordinate items with categories, particularly where all or part of a conceptual hierarchy already exists.

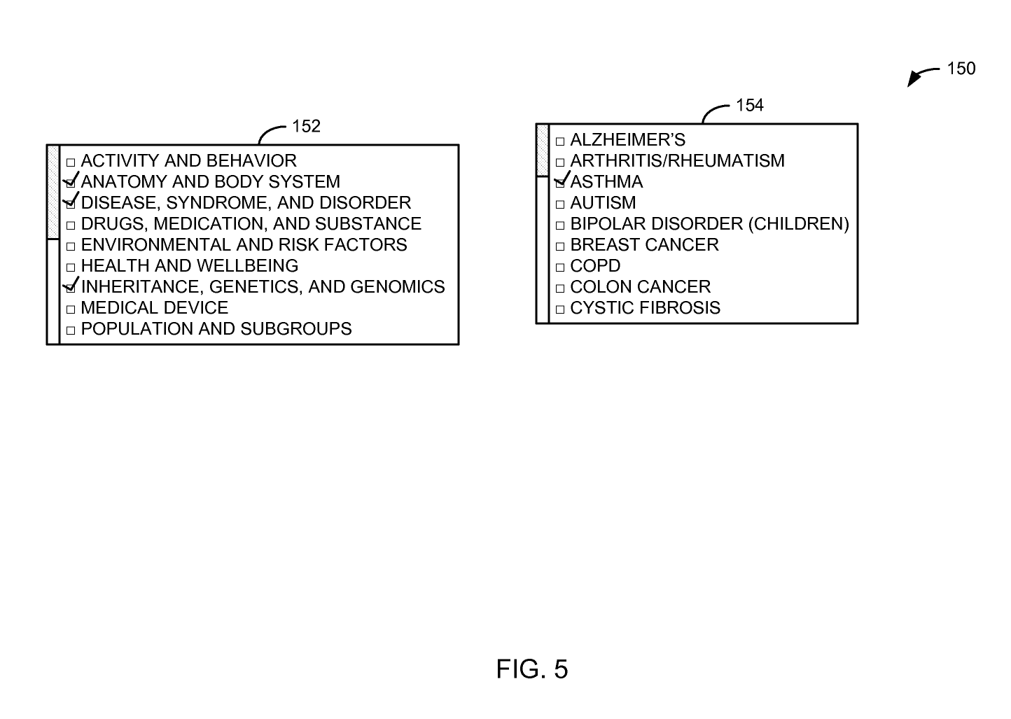

FIG. 5 represents the example implementation 150 of FIG. 4 after step 106 of FIG. 3. In this screenshot, the selection of the top-level categories 152 has been employed to display a set of subordinate items 154, specifically more narrow categories, to the user. In the illustrated implementation, each of the first set of subordinate items comprises a set of medical topics. Since the user selected “Anatomy and Body System,” “Disease, Syndrome, and Disorder,” and “Inheritance, Genetics, and Genomics,” only those topics that relate to all three categories (semantic types) are displayed to the user. In the illustrated implementation, the topics can be assigned to the first set of categories by a human expert. In one implementation, each topic is applied to one of first set of categories comprises by applying formal concept analysis with each of the first set of categories representing an attribute of the formal concept analysis, with each of the topics representing an object of the formal concept analysis.

At 108, the user is allowed to select at least one of the displayed proper subset of the first set of subordinate items. At 110, a proper subset of a second set of subordinate items is displayed. Each of the second set of subordinate items is associated with at least one of the first set of subordinate items, and the proper subset of the second set of subordinate items includes only items from the second set of subordinate items that are associated with all of the selected items from the first set of subordinate items. In one implementation, the second set of subordinate items can be assigned to the first set of subordinate items by human experts. In another implementation, they can be assigned to the first set of subordinate items via an expert system according to their semantic content. This is particularly useful when the second set of subordinate items are the content items.

Where the second set of subordinate items are not the content items, the method can continue, with the user selecting at least one of the displayed proper subset of the second set of subordinate items, and a proper subset of a third set of subordinate items can be displayed according to their association with the selected items from the second set of subordinate items, such that the proper subset of the third set of subordinate items includes only items from the third set of subordinate items that are associated with all of the selected proper subset of the second set of subordinate items. This can be continued in a similar manner for as many levels as is necessary to appropriately organize the content items.

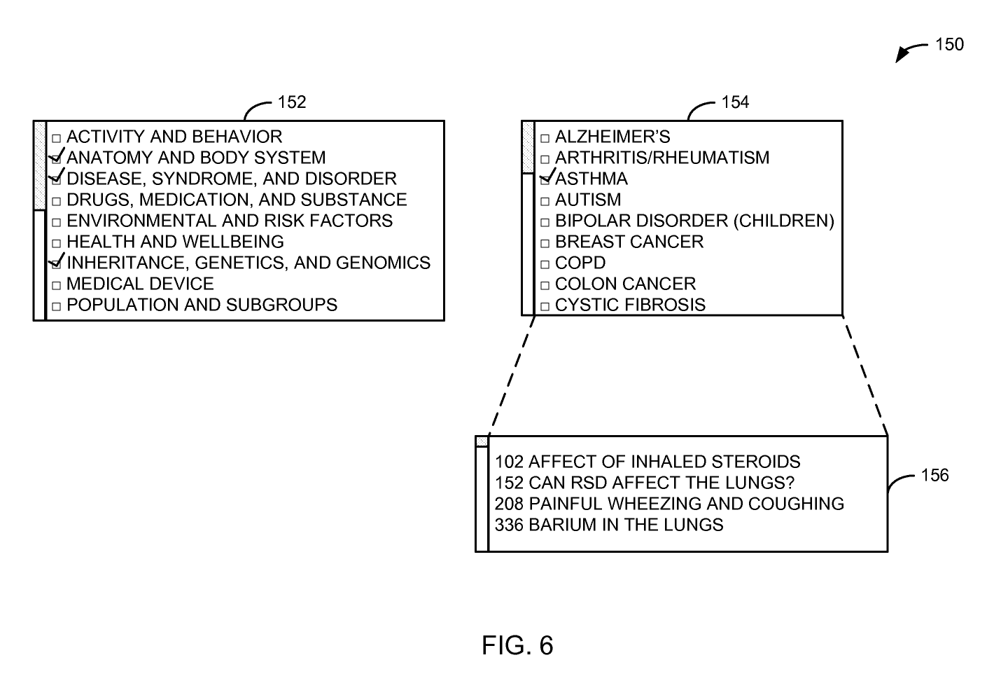

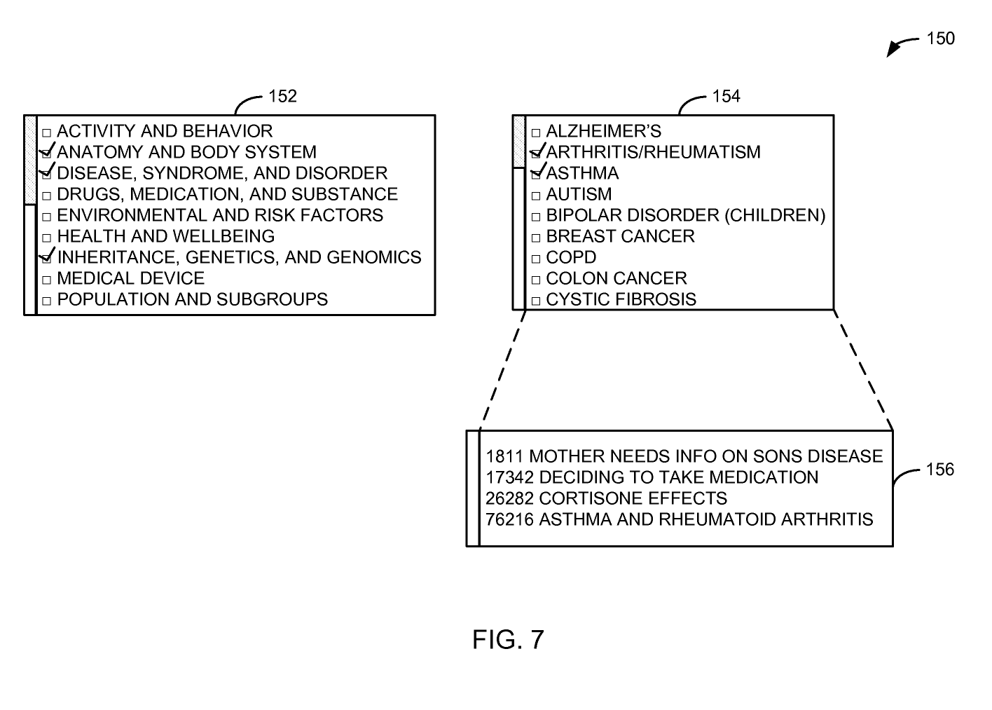

FIG. 6 represents the example implementation 150 of FIG. 4 after step 110 of FIG. 3. In FIG. 6, the user has selected the “Asthma” topic from the list of available topics 154, and a list of content items 156 relating to Asthma is displayed to the user. In the illustrated implementation, the content items 156 are articles on medical topics. In FIG. 7, the user has selected the “Arthritis/Rheumatism” topic in addition to the “Asthma” topic. Due to the conjunctive nature of the system, this sharply reduces the number of content items 156 to the four displayed. It will be appreciated that, by allowing the user multiple categories and topics for describing the desired content item and conjunctively limiting the displayed results to those items fitting all of the categories, the efficiency of the search can be greatly increased.

Research for improving the access of online consumer health information can be considered a part of the general area of Information Retrieval, which recognizes two basic modes of information access. In direct search, a user, knowing what to look for, comes with specific pieces of information about a disease, procedure, or medication, or other related description and tries to retrieve a corresponding set of responses. In navigational exploration, the goal is to explore the content in an online source, to see “what is there.” In this mode, the consumer may not have a specific target or cannot easily and effectively formulate a descriptive search, and must rely on navigational menus or “facets” to browse and explore the content.

In most cases, direct search is accompanied by navigational exploration to help the user “finding needles in a haystack:” the volume of search results can be overwhelmingly large and needs to be further structured to allow relevant information to be located. For example, in one study, fourteen health information sites reported 3,735 links in the first page of search results. Among 389 sampled relevant links, about a quarter did not lead to a content page within ten clicks. This demonstrates that direct search alone is inadequate, and the inventors have provided an improved mechanism for navigational exploration.

The benefits of navigational exploration have been long recognized by the faceted search community, but standard facets are limited in their utility for organizing consumer health information because of the requirement of a set of rigid properties on facets. The inventors have developed Concept-guided Automatic Organization of Consumer Health information (iCOACH), a systematic method using Formal Concept Analysis and the Unified Medical Language System (UMLS) for organization and for supporting navigational exploration of consumer health information.

Formal Concept Analysis (FCA) is a lattice-based method for extracting higher-level organizational information from lower-level classification of objects according to their attributes. FCA builds from a formal context (or context), (O, A, R), with O a collection of objects (e.g. questions or content items), A a collection of attributes (e.g. topics or subordinate items), and R a binary relation from O to A. R is specified by a table, indicating relations between corresponding objects and the corresponding attributes. FCA clusters objects into a concept hierarchy, called a concept lattice, suitable for visualization and quantitative analysis with considerable organizational power. Each logical cluster is called a formal concept, representing a basic unit of information by harmonizing subsets of objects (the extent) and their associated attributes (the intent) using a closure operation. In the proposed information retrieval method, we use FCA for content organization and dynamic content-group generation, driving a navigational exploration interface. Using FCA this way involves the creation of a formal context and the dynamic generation of the corresponding formal concept (i.e., its intent and extent) based on a select subset of attributes.

The conjunctive search of the present invention can contrasted with a faceted search approach. Faceted search combines direct search with navigational exploration to provide many different interwoven ways to access the same entities. Each facet represents an independent, disjoint dimension of information, typically consisting of a set of “values.” The entities are then assigned to specific values in facets, allowing them to be accessed from any of the relevant facets and values. The basic requirements for faceted search involves the design of the facets, the classification of entities into the facets, and interfaces allowing the user to intuitively interact with and navigate to targeted entities.

The iCOACH implementation of conjunctive search shares the navigational exploration objective of faceted search, without the constraints typically imposed to facets. Entities in iCOACH are consumer health questions, which do not come with a naturally useful set of facets and values. Typical facet values such as the dates questions were posted and the names of the experts who answered the questions, are of limited value for information seeking by the consumer. The topics a question is tagged with could serve as the basis for faceted search. However, because a basic premise of faceted search is value “mutual exclusivity”, it prevents the assignment of multiple topics to a single question. iCOACH overcomes such constraints by employing “chain-linked” formal contexts to achieve a general facet-like navigational exploration framework.

iCOACH has three main features. One is that it overcomes one of the disadvantages of tree-based, branching organizational structure found in most web sites. For example, questions in the current NetWellness site are organized around topics such as “Breast Cancer” and “Women's Health.” A consumer interested in Fibroadenomas may try to find such questions from the “Breast Cancer” topic area, but it might be reasonably put under the topic of “Women's Health.” Such an organizational structure puts additional navigational burden on the consumer to find the right pieces of information. Organizing consumer health information according to a conjunctive structure determined by FCA allows content items to be located from multiple pathways. It achieves a better “organizational precision and recall,” in the sense that items, if found, are in their right place (precision) and an item is located at where it should be (recall).

The second feature of iCOACH is its distinction from existing body of work on FCA-based menu-design and organization. One of the main challenges in such an approach is finding appropriate labeling for composite concept nodes, representing a conjunctive aggregation of attributes. For example, finding a concise and accurate label for a new category representing the intersection of “Anatomy and Body System,” “Disease, Syndrome and Disorder,” and “Inheritance, Genetics and Genomics” is difficult, if not impossible. iCOACH avoids this problem by allowing multiple (conjunctive) selection by a user to drill-down to the corresponding concept node in the hierarchy generated using FCA without having to name the concept node. This removes the need to navigate nested menu hierarchies as well. The third feature of iCOACH is that it is a facet-like approach without requiring strict conformation to the standard notion of “facet” in its defining properties of “exhaustivity,” “mutual exclusivity,” or “enumeration”. Instead, iCOACH employs the chaining of several formal contexts to achieve a facet-like system architecture for navigational exploration.

To determine the effectiveness of the proposed search methodology, a study was performed using Amazon Mechanical Turk (MTurk) to compare three consumer health search interfaces, specifically exploratory navigation with keyword search in accordance with the systems and methods provided herein, keyword search only, and Google-style search. MTurk crowdsourcing allowed for performance of comparative search-interface evaluation in a timely and cost-effectively manner, with a relatively large number of study subjects recruited anonymously. NetWellness, a database of health questions, was utilized for the study. Launched in 1995, NetWellness was one of the first consumer health websites on the internet. A partnership of three Ohio research universities, NetWellness (NW; http://www.netwellness.org) offers understandable health information for a general audience. To develop an exploratory navigation interface for the repository of over 60,000 NW questions, MetaMap was used for assigning UMLS Concept Unique Identifiers (CUIs) to these questions. The CUI tags were further used for assigning NW questions to one or several of the ninety-nine pre-defined NW topics.

To conduct the study, two health information retrieval systems were developed and compared with the existing search interfaces. The two new interfaces included an exploratory navigation interface coupled with keyword search, designed in accordance with an aspect of the present invention and a keyword based search interface. The existing search interface was modeled as a Google search engine query specifying “NetWellness” as part of the search string or NW's advanced search engine. Within-subject design was used with search mode as the factor, in three levels, which was counterbalanced appropriately to avoid order bias. Nine consumer health related search tasks were designed based on NW's question repository, such as “What are the typical vision problems associated with diabetes?” Ninety anonymous and unique MTurk workers answered questions for each task using the three consumer health search interfaces. Each task included a rating of the level of difficulty of the task. Additional questions served as validation to avoid guesses. Six MTurk health information tasks were designed to take the orders of search interfaces into account (ABC, ACB, BAC, BCA, CAB, and CBA). This resulted in six groups with fifteen workers each that were randomly assigned to work on the surveys. Each worker completed nine tasks total, with three tasks for each search mode.

The results of the study confirmed that the exploratory navigation with keyword search interface improved over keyword search, which in turn improved over the Google-style search. Repeated-measures ANOVA analysis of the data showed statistically significant difference among the three interfaces (p-value=3.519×10⁻⁶<0.001). A Wilcoxon signed-rank test (one-tailed) between the key showed that exploratory navigation with keyword search significantly enhances over keyword search (p-value=0.015). Paired t-tests (one-tailed) between the existing search interface showed that the exploratory navigation with keyword search method significantly improves over the existing search interface (p-value=1.854×10⁻⁶), as does keyword search (p-value=0.014). Keyword search also played the role of a control, as it represents the method under test without the function for explorative navigation. Accordingly, even accounting for possible biases, the study confirms that a search interface facilitating explorative navigation does enhance consumer health information access, even though this additional mode is not the most familiar.

FIG. 8 illustrates a computer system 200 that can be employed to implement systems and methods described herein, such as based on computer executable instructions running on the computer system. The computer system 200 can be implemented on one or more general purpose networked computer systems, embedded computer systems, routers, switches, server devices, client devices, various intermediate devices/nodes and/or stand alone computer systems.

The computer system 200 includes a processor 202 and a system memory 204. Dual microprocessors and other multi-processor architectures can also be utilized as the processor 202. The processor 202 and system memory 204 can be coupled by any of several types of bus structures, including a memory bus or memory controller, a peripheral bus, and a local bus using any of a variety of bus architectures. The system memory 204 includes read only memory (ROM) 208 and random access memory (RAM) 210. A basic input/output system (BIOS) can reside in the ROM 208, generally containing the basic routines that help to transfer information between elements within the computer system 200, such as a reset or power-up.

The computer system 200 can include one or more types of long-term data storage 214, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 202 by a drive interface 216. The long-term storage components 214 provide nonvolatile storage of data, data structures, and computer-executable instructions for the computer system 200. A number of program modules may also be stored in one or more of the drives as well as in the RAM 210, including an operating system, one or more application programs, other program modules, and program data.

A user may enter commands and information into the computer system 200 through one or more input devices 220, such as a keyboard, a touchscreen, and/or a pointing device (e.g., a mouse). It will be appreciated that the one or more input devices 220 can include one or more sensor assemblies transmitting acceleration data to the computer 200 for further processing. These and other input devices are often connected to the processor 202 through a device interface 222. For example, the input devices can be connected to the system bus by one or more a parallel port, a serial port or a USB. One or more output device(s) 224, such as a visual display device or printer, can also be connected to the processor 202 via the device interface 222.

The computer system 200 may operate in a networked environment using logical connections (e.g., a local area network (LAN) or wide area network (WAN)) to one or more remote computers 230. A given remote computer 230 may be a workstation, a computer system, a router, a peer device, or other common network node, and typically includes many or all of the elements described relative to the computer system 200. The computer system 200 can communicate with the remote computers 230 via a network interface 232, such as a wired or wireless network interface card or modem. In a networked environment, application programs and program data depicted relative to the computer system 200, or portions thereof, may be stored in memory associated with the remote computers 230.

The invention has been disclosed illustratively. Accordingly, the terminology employed throughout the disclosure should be read in an exemplary rather than a limiting manner. Although minor modifications of the invention will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

Having described the invention, we claim:

1. A non-transitory computer readable medium storing executable instructions executable by an associated processor to perform a method for selectively displaying discrete content items to a user; the method comprising:
displaying a first set of categories to the user;
allowing the user to select a proper subset of the first set of categories;
displaying a proper subset of a first set of subordinate items, each of the first set of subordinate items being associated with at least one of the first set of categories, the proper subset of the first set of subordinate items comprising only items from the first set of subordinate items that are associated with all of the selected proper subset of the first set of categories;
allowing the user to select at least one of the displayed proper subset of the first set of subordinate items; and
displaying a proper subset of a second set of subordinate items, each of the second set of subordinate items being associated with at least one of the first set of subordinate items, the proper subset of the second set of subordinate items comprising only items from the second set of subordinate items that are associated with all of the selected at least one of the first set of subordinate items.

2. The non-transitory computer readable medium of claim 1, wherein the second set of subordinate items comprises the discrete set of content items.

3. The non-transitory computer readable medium of claim 2, the method further comprising classifying each of the set of content items to at least one of the first set of subordinate items according to a semantic content of the content item.

4. The non-transitory computer readable medium of claim 1, the method further comprising:
allowing the user to select at least one of the displayed proper subset of the second set of subordinate items; and
displaying a proper subset of a third set of subordinate items, each of the third set of subordinate items being associated with at least one of the second set of subordinate items, the proper subset of the third set of subordinate items comprising only items from the third set of subordinate items that are associated with all of the selected proper subset of the second set of subordinate items.

5. The non-transitory computer readable medium of claim 1, wherein each of the set of content items includes at least one of a document, a video, a webpage, a picture, and a hypertext link.

6. The non-transitory computer readable medium of claim 1, wherein each of the first set of subordinate items comprises a set of topic label tags (TLTs) and the method further comprises assigning each TLT to one of first set of categories.

7. The non-transitory computer readable medium of claim 6, wherein each of the second set of subordinate items comprises the discrete set of content items is associated with one of the TLTs according to its semantic content.

8. The non-transitory computer readable medium of claim 6, assigning each TLT to one of first set of categories comprises assigning each TLT to one of first set of categories via a human expert.

9. The non-transitory computer readable medium of claim 6, wherein each of the first set of categories is selected to comprise a set of at least one semantic type from the Unified Medical Language System.

10. The non-transitory computer readable medium of claim 9, wherein assigning each TLT to one of first set of categories comprises applying formal concept analysis with each of the first set of categories representing an attribute of the formal concept analysis, and each of the TLTs representing an object of the formal concept analysis.

11. A method comprising:
allowing the user to select a plural, proper subset of a first set of categories via an input device;
displaying a proper subset of a first set of subordinate items according to the selected plural, proper subset of the first set of categories by the user;
allowing the user to select a plurality of subordinate items of a displayed proper subset of the first set of subordinate items at the display via the input device; and
displaying a proper subset of a second set of subordinate items according to the selected plurality of the proper subset of the first set of subordinate items.

12. The method of claim 11, wherein each of the first set of subordinate items is associated with at least one of the set of top level categories, and the proper subset of the first set of subordinate items includes only items from the first set of subordinate items that are associated with all of the selected proper subset of the set of top level categories.

13. The method of claim 12, wherein each of the second set of subordinate items is associated with at least one of the set of first set of subordinate items, and the proper subset of the second set of subordinate items includes only items from the second set of subordinate items that are associated with all of the selected proper subset of the set of first set of subordinate items.

14. The method of claim 11, wherein the second set of subordinate items comprises a discrete set of content items, each content item being one of a document, a video, a webpage, a picture, and a hypertext link.

15. The method of claim 14, further comprising classifying each of the set of content items to at least one of the first set of subordinate items according to a semantic content of the content item.

16. The method of claim 14, further comprising:
allowing the user to select at least one of the displayed proper subset of the second set of subordinate items; and
displaying a proper subset of a third set of subordinate items, each of the third set of subordinate items being associated with at least one of the second set of subordinate items, the proper subset of the third set of subordinate items comprising only items from the third set of subordinate items that are associated with all of the selected proper subset of the second set of subordinate items.

17. The method of claim 11, further comprising assigning each of the first set of subordinate items to one of first set of categories comprises applying formal concept analysis with each of the first set of categories representing an attribute of the formal concept analysis, and each of the subordinate items representing an object of the formal concept analysis.

18. A system comprising:
a processor;
a display;
an input device; and
a set of at least one non-transitory computer readable medium, operatively connected to the processor, and storing executable instructions executable by the processor, the instructions comprising:
a user interface configured to display a set of medical categories to the user at the display and allow the user to select a proper subset of the first set of medical categories via the input device; and
a conjunctive selection engine configured to determine a proper subset of a set of medical topics comprising only topics from the set of medical topics that are associated with all of the selected proper subset of the set of medical categories and provide the determined proper subset of the set of medical topics to the user interface for display;
wherein the user interface is further configured to allow the user to select at least one of the displayed proper subset of the first set of medical topics via the input device, the conjunctive selection engine determining a proper subset of a set of content items comprising only content items from the set of content items that are associated with all of the selected proper subset of the set of medical topics.

19. The system of claim 18, wherein each of the set of content items includes at least one of a document, a video, a webpage, a picture, and a hypertext link.

20. The system of claim 18, the method further comprising classifying each of the set of content items to at least one of the first set of medical topics according to a semantic content of the content item.
